(19) United States
(12) Patent Application Publication
(10) Pub. No.: US 2020/0142258 A1
(43) Pub. Date: May 7, 2020

(54) LIQUID CRYSTAL DISPLAY DEVICE AND BACKLIGHT MODULE THEREOF

(71) Applicant: Huizhou China Star Optoelectronics Technology Co., Ltd., Huizhou Guangdong (CN)

(72) Inventor: Xiaohong JING, Huizhou Guangdong (CN)

(21) Appl. No.: 15/749,489

(22) PCT Filed: Nov. 6, 2017
(86) PCT No.: PCT/CN2017/109466

§ 371 Date: Nov. 6, 2018

(30) Foreign Application Priority Data
Oct. 13, 2017 (CN) 201710954699.9

(51) Int. Cl. G02F 1/1335; G02B 3/00

(52) U.S. Cl. CPC G02F 1/133603; G02B 3/0043; G02F 2001/133614; G02F 2001/133613; G02F 1/133605

(57) ABSTRACT

The present disclosure provides a liquid crystal display and a backlight unit thereof, the backlight unit includes a plurality of light emitting units, a reflective layer, a light guide plate and an optical film set. The light guide plate is located between the reflective layer and the optical film set, the light guide plate set a plurality of receiving portions on the surface facing the reflective layer, the plurality of receiving portions correspond one on one to the plurality of light emitting units, and the light emitting units are disposed on the reflective layer and received in the receiving portions. The backlight unit through the light guide plate sets the light emitting units at the bottom of the light guide plate, in order to achieve the combination of direct edge type combination, and make it satisfied with the need of highlighting and multi-partitioning while reducing the thickness.

### RELATED APPLICATIONS

The present application is a National Phase of International Application Number PCT/CN2017/109466, filed Nov. 6, 2017, and claims the priority of China Application No. 201710954699.9, filed Oct. 13, 2017.

### TECHNICAL FIELD

The present disclosure relates to the field of liquid crystal display technology, and in particular to a liquid crystal display and a backlight unit.

### BACKGROUND

At this stage, the appearance of liquid crystal display is more and more thin, optical brightness requirements are getting higher and higher. At present, the backlight structure of the liquid crystal display includes side-entry type and direct-type. In the direct type backlight structure, the light source directly emits from the front of the module through the light mixing and diffusing plate. The side-type backlight structure guides the side light source to positive light through the light guide plate, The direct type in the brightness and backlight partition has a larger design space, but in thin the thickness, due to the mixing distance factors, has more limited, cannot be ultra-thin; the existing backlight structure of ultra-thin liquid crystal display products are basically side-in type, side-in type has more advantages in thickness design, but the brightness and the number of backlight partitions enhancement is not better than direct type. Therefore, in order to cope with the market trend, it is necessary to provide a backlight unit compatible with both advantages while avoiding the disadvantages of both.

### Content of the Invention

In order to solve the deficiencies of the prior art, the present disclosure provides a liquid crystal display and a backlight unit thereof, which can meet the needs of high brightness and multi-division while reducing the thickness.

A specific technical plan proposed by the present disclosure is to provide a backlight unit, wherein comprising a plurality of light emitting units, a reflective layer, a light guide plate and an optical film set, wherein the light guide plate is located between the reflective layer and the optical film set, wherein a surface of the light guide plate facing the reflective layer is set with a plurality of receiving portions, the plurality of receiving portions correspond one on one to the plurality of light emitting units, and the light emitting units are disposed on the reflective layer and accommodated in the receiving portions.

Optionally, the receiving portion is a concave structure, and shape of the concave structure is a cylindrical shape, a funnel shape or a dome shape.

Optionally, a side of the concave structure opposite to the reflective layer is an atomized surface.

Optionally, the receiving portion is a through hole, and the through hole has a cylindrical shape, a funnel shape, or a dome shape.

Optionally, the light emitting unit includes an LED lamp and a transparent cover, and the LED lamp is received in the transparent cover.

Optionally, the light emitting unit further comprises a fluorescent coating coated on the inner surface of the transparent cover.

Optionally, the transparent cover is a lens.

Optionally, the backlight units further comprising a plurality of scattering dots is disposed on a surface of the light guide plate facing the reflective layer, and the plurality of scattering dots is disposed between two adjacent, the receiving portions.

The present disclosure also provides a liquid crystal display. Wherein the liquid crystal display includes a display unit and the backlight units as described above, wherein the display module is disposed on the optical film set.

The present disclosure proposed backlight units include a plurality of light emitting units, a reflective layer, a light guide plate, and an optical film set. A surface of the light guide plate facing the reflective layer is set with a plurality of receiving portions. The light emitting unit is set on the reflective layer and accommodated in the receiving portion, through the light guide plate and set the light emitting unit at the bottom of the light guide plate so as to realize the combination of the direct type and the side-in type, to meet the demand of highlighting and multi-divisions while reducing the thickness.

### BRIEF DESCRIPTION OF THE DRAWINGS

FIG. 1 is a schematic structural view of the liquid crystal display of Example 1;

FIG. 2 is a schematic structural view of the backlight units of Example 1;

FIG. 3 is a schematic structural view of the receiving portion of Example 1;

FIG. 4 is a schematic structural view of the backlight units of Example 2;

FIG. 5 is a schematic view of the structure of the receiving portion of example 2.

### DETAILED DESCRIPTION OF IMPLEMENT PROGRAM

Hereinafter, embodiments of the present disclosure will be described in detail with reference to the accompanying drawings. However, the disclosure may be embodied in many different forms, and should not be construed as limited to the specific embodiments set forth herein. Rather, these embodiments are provided to explain the principles of the disclosure and its practical application to thereby enable those of ordinary skill in the art to understand various embodiments of the disclosure and various modifications as are suited to the particular use contemplated. In the drawings, the same reference numerals will always be used to refer to the same elements.

### Example 1

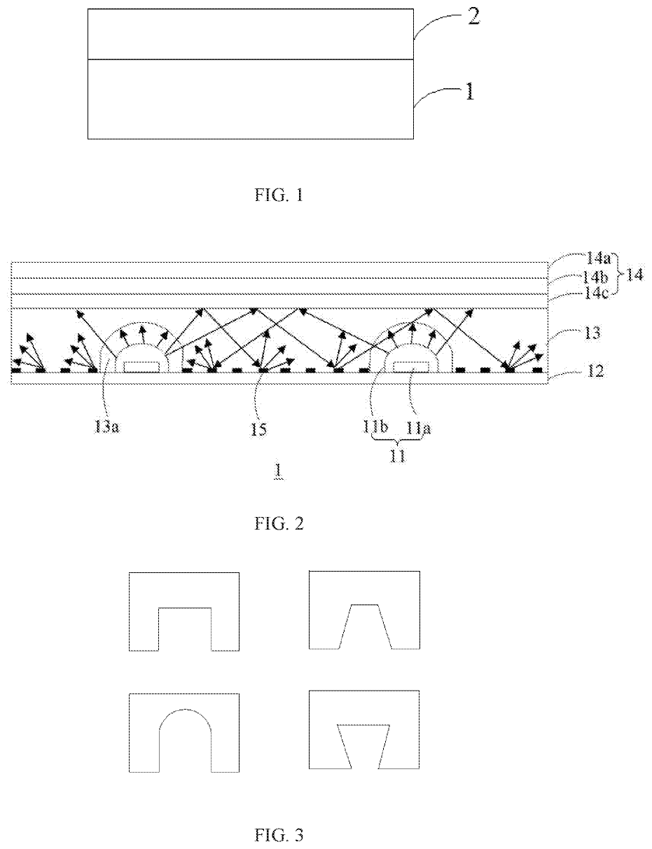

Referring to FIG. 1 to 3, the liquid crystal display in this embodiment includes a backlight unit 1 and a display module 2. The backlight unit 1 includes a plurality of light emitting units 11, a reflective layer 12, a light guide plate 13 and an optical film set 14. The light guide plate 13 is located between the reflective layer 12 and the optical film set 14. One surface of light guide plate 13 facing the reflective layer 12 has a plurality of receiving portions 13a. The plurality of receiving portions 13a corresponds to the plurality of light emitting units 11 one on one. The light emitting unit 11 set on the reflective layer 12 and accommodated in the receiving portion 13a.

In this embodiment, the receiving portion 13a is the concave structure from transmitted surfaces of light guide plate 13 bottom surface facing the light guide plate 13. The shape of the concave structure is a cylindrical shape, a funnel shape, or a dome shape. The shape of the funnel shape may include an inverted funnel which top diameter is less than the diameter of the bottom, or an upright funnel with a top diameter larger than the diameter of the bottom, as shown in FIG. 3. The size of the concave structure opening is larger than the size of the light emitting unit 11, that is, the sidewall of light emitting unit 11 and the concave structure has a predetermined gap so that the light emitting unit 11 has more light-mixing space and at the same time prevents the light emitting unit 11 to press the light guide plate 13 during thermal expansion. Here, the transmitted surface of the light guide plate 13 refers to the surface of the light guide plate 13 facing the optical film set 14.

In order to avoid uneven brightness and darkness, an opposite side of the concave structure to the reflective layer 12 is an atomized surface, that is, a surface of the concave structure opposite to the reflective layer 12 is atomized, this can make the light emitted from the light guide plate 13 be more uniform. The light emitted by the light emitting unit 11 enters the light guide plate 13 from different directions. The light enters into the light guide plate 13 after through many reflections then after shot out from the transmitted surface of light guide plate 13 and shot into the optical film set 14.

The plurality of light emitting units 11 are evenly distributed on the reflective layer 12, and the number of the light emitting units 11 or the arrangement method thereof can be determined according to actual needs and the size of the light guide plate 13. The light emitting unit 11 includes an LED lamp 11a and a transparent cover 11b, and the LED lamp 11a is accommodated in the transparent cover 11b. Among them, the LED lamp 11a may be a white LED. The LED lamp 11a may also be a blue LED. When the LED lamp 11a is a blue LED, the light emitting unit 11 further includes a fluorescent coating coated on the inner surface of the transparent cover 11b. The fluorescent coating may be a yellow phosphor, red and green mixed phosphor and yellow and red mixed phosphor. The blue light emitted by the blue LED excites the fluorescent coating, and the light emitted by the fluorescent coating is mixed with the light emitted by the blue LED so that the light emitted from the transparent cover 11b is white light. In this embodiment, the transparent cover 11b is a lens, and the light path of the LED lamp 11a can be adjusted by the lens, so that the light emitting unit 11 has a better light emitting effect.

The backlight unit 1 further includes a plurality of scattering dots 15 disposed on a surface of the light guide plate 13 facing the reflective layer 12. The plurality of scattering dots 15 are disposed between two adjacent receiving portions 13a, that is, the area of the light guide plate 13 bottom with no setting of receiving portions 13a are all set with dots 15, and the light reflected by the reflective layer 12 is more evenly distributed through the dots 15.

The reflective layer 12 in this embodiment may be a single reflective sheet, which is located at the bottom of the light guide plate 13. The reflective layer 12 may also be a reflective coating layer coated on the bottom of the light guide plate 13.

The optical film set 14 includes an upper diffusion sheet 14a, a light enhancement sheet 14b and a lower diffusion sheet 14c. The upper diffusion sheet 14a is located between the light enhancement sheet 14b and the display unit 2. The lower diffusion sheet 14c is located between the light enhancement sheet 14b and the light guide plate 13. The light-adding sheet 14b is for the collection of dispersed light emitted by the lower diffusion sheet 14c The usage of lower diffusion sheet 14c is to collect the light emitting from the transmitted surface of light guide plate 13 and project evenly on light enhancement sheet 14b, the light enhancement sheet 14b is used to proceed the collection of the disperse light emitted from the lower diffusion sheet 14c to increase brightness, the upper diffusion sheet 14a is used for and diffuse the sheet 14a is used to proceed atomization of the light emitted from the light enhancement sheet 14b and uniformly emit the light.

In the present embodiment, through the light guide plate 13 and set the light emitting unit 11 at the bottom of the light guide plate 13, in order to achieve the combination of the direct type and the side-entry type, so as to meet the demand of high brightness and multi-division while reducing the thickness.

### Example 2

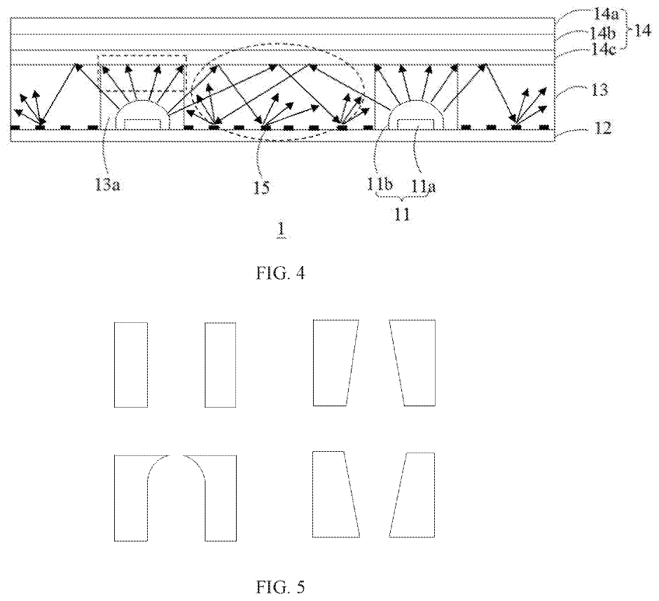

Referring to FIG. 4 and FIG. 5, the difference between this embodiment and embodiment 1 is that the receiving portion 13a is a through hole penetrating the light guide plate 13.

Specifically, the shape of the through hole is cylindrical, funnel-shaped or dome-shaped, wherein the funnel shape may include an inverted funnel shape with a top diameter smaller than that of the bottom diameter or an upright funnel shape has a top diameter larger than the bottom diameter, as shown in FIG. 5. The size of the bottom of the through hole is larger than the size of the light emitting unit 11, that is, the light emitting unit 11 and the inner wall of the through hole has a predetermined gap, so that the light emitting unit 11 has more light mixing space and at the same time prevents the light emitting unit 11 pressing the light guide plate 13 during thermal expansion.

In this embodiment, a part of the light emitted by the light emitting unit 11 is directly shooting into the optical film set 14 through the through-hole, and the light path of the light is a direct light path, as shown by the dotted line square box in FIG. 4. The light emitted by the light emitting unit 11 part of it enters into the light guide plate 13 through the inner wall through-hole, inside of the light guide plate 13 after through many times reflections and shot out from the transmitted surface of the light guide plate. In this time, the light path is a side-entry type, as showed by the dotted oval box in FIG. 4.

Based on the first embodiment, the present embodiment can further meet the requirements of highlighting and multi-partitioning while reducing the thickness. The above descriptions are merely specific implementation manners of the present application. It should point out that to those common technical personnel art area, still can make some improvements and modifications without departing from the principle of the present application. These improvements and modifications also should be regarded as the scope of protection of this application.

What is claimed is:

1. A backlight unit, comprising a plurality of light emitting units, a reflective layer, a light guide plate and an optical film set, wherein the light guide plate is located between the reflective layer and the optical film set, a surface of the light guide plate facing the reflective layer is set with a plurality of receiving portions, the plurality of receiving portions correspond one on one to the plurality of light emitting units, and the light emitting units are disposed on the reflective layer and accommodated in the receiving portions.

2. The backlight unit according to claim 1, wherein the receiving portion is a concave structure and shape of the concave structure is a cylindrical shape, a funnel shape or a dome shape.

3. The backlight unit according to claim 2, wherein a surface of the concave structure opposite to the reflective layer is an atomized surface.

4. The backlight unit according to claim 1, wherein the receiving portion is a through hole, and shape of the through hole is a cylindrical shape, a funnel shape, or a dome shape.

5. The backlight unit according to claim 1, wherein the light emitting unit comprises an LED lamp and a transparent cover, and the LED lamp is received in the transparent cover.

6. The backlight unit according to claim 5, wherein the light emitting unit further comprises a fluorescent coating coated on an inner surface of the transparent cover.

7. The backlight unit according to claim 6, wherein the transparent cover is a lens.

8. The backlight unit according to claim 1, further comprising a plurality of scattering dots disposed on a surface of the light guide plate facing the reflective layer, the plurality of scattering dots being disposed between two adjacent receiving portions.

9. A liquid crystal display device, comprising a display module and a backlight unit, the display module being disposed on an optical film set, the backlight unit comprising a plurality of light emitting units, a reflective layer, a light guide plate, and an optical film set, wherein the light guide plate is located between the reflective layer and the optical film set, a surface of the light guide plate facing the reflective layer is set with a plurality of receiving portions, the plurality of receiving portions correspond one on one to the plurality of the light emitting units, the light emitting units are disposed on the reflective layer and accommodated in the receiving portion.

10. The liquid crystal display device according to claim 9, wherein the receiving portion is a concave structure, and shape of the concave structure is a cylindrical shape, a funnel shape or a dome shape.

11. The liquid crystal display device according to claim 10, wherein a side of the concave structure opposite to the reflective layer is an atomization surface.

12. The liquid crystal display device according to claim 9, wherein the receiving portion is a through hole, and shape of the through hole is a cylindrical shape, a funnel shape, or a dome shape.

13. The liquid crystal display device according to claim 9, wherein the light emitting unit comprises an LED lamp and a transparent cover, and the LED lamp is received in the transparent cover.

14. The liquid crystal display device according to claim 13, wherein the light emitting unit further comprises a fluorescent coating coated on an inner surface of the transparent cover.

15. The liquid crystal display device according to claim 14, wherein the transparent cover is a lens.

16. The liquid crystal display device according to claim 9, further comprising a plurality of scattering dots disposed on a surface of the light guide plate facing the reflective layer, and the plurality of scattering dots being disposed between two adjacent receiving portions.
